(19) United States
(12) Patent Application Publication
(10) Pub. No.: US 2023/0324784 A1
(43) Pub. Date: Oct. 12, 2023

(54) X-RAY DETECTING FILM, METHODS OF FABRICATION AND USES THEREOF

(71) Applicants: Fuzhou University, Fujian (CN); National University of Singapore, Singapore (SG)

(72) Inventors: Xiaogang LIU, Singapore (SG); Qiushui CHEN, Singapore (SG); Huanghao YANG, Fujian (CN); Xiangyu OU, Fujian (CN)

(21) Appl. No.: 17/998,638

(22) PCT Filed: May 14, 2021
(86) PCT No.: PCT/SG2021/050265

§ 371 Date: Nov. 11, 2022

(30) Foreign Application Priority Data
May 15, 2020 (CN) 202010415013.0

(51) Int. Cl. G03C 1/705; G01T 1/20; G03C 5/16; G03C 5/56; C09K 11/77

(52) U.S. Cl. CPC G03C 1/705; G01T 1/2012; G03C 5/16; G03C 2200/60; C09K 11/7773; G03C 2005/168; G03C 5/56

(57) ABSTRACT

The present invention relates, in general terms, to X-ray detecting films and uses thereof. The present invention also relates to methods of fabricating the X-ray detecting films. In particular, the X-ray detecting film comprises persistent luminescent nanoparticles dispersed within a flexible polymer matrix, wherein the persistent luminescent nanoparticles are dispersed in the flexible polymer matrix at a concentration of about 0.1% to about 100%.

### TECHNICAL FIELD

The present invention relates, in general terms, to X-ray detecting films and uses thereof. The present invention also relates to methods of fabricating the X-ray detecting films.

### BACKGROUND

Over the past decades, several types of flat-panel X-ray detectors, mainly based on direct conversion of X-ray energy into electrical charges or indirect conversion using a scintillating material, have been implemented. Many X-ray detection technologies require integration of flat-panel detectors with thin-film transistors (TFT) consisting of a pixelated photodiode array deposited on a glass substrate. Although the integration provided by the thin-film transistor is a powerful tool that can be used to produce high sensitivity for X-ray detection and graphic reconstruction, it also presents substantial challenges. Apart from high cost of thin-film transistors, bulky flat-panel detectors are not applicable for 3D X-ray imaging of curved or irregularly-shaped substrates. Despite enormous efforts, flexible X-ray detectors have not been demonstrated yet because this requires stringent dual requirements of a flexible thin-film transistor substrate with long-term stability and a thin layer of X-ray conversion materials able to conformably attach to the flexible substrate.

It would be desirable to overcome or ameliorate at least one of the above-described problems, or at least to provide a useful alternative.

### SUMMARY

The present invention provides an X-ray detecting film, comprising persistent luminescent nanoparticles dispersed within a flexible polymer matrix; wherein the persistent luminescent nanoparticles are lanthanide-doped nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd³⁺; Sr₂MgSi₂O₇:Eu²⁺,Dy³⁺; CaS:Eu²⁺,Dy³⁺; Y₂O₂S:Eu³⁺,Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); Eu²⁺ doped silicate or borate glasses; and

wherein the persistent luminescent nanoparticles are dispersed in the flexible polymer matrix at a concentration of about 0.1% to about 100%.

In some embodiments, the persistent luminescent nanoparticles are dispersed in the flexible polymer matrix at a concentration of about 1% to about 10%.

Advantageously, the use of persistent luminescent nanoparticles allows for a long and extremely persistent luminescence. Additionally, the electrons are stable in electron traps at ambient temperature, and can be released through thermal stimulation or optical stimulation (most case of strong source such as laser). In this regard, when the film is positioned adjacent to an object to be imaged, the persistent luminescent nanoparticles are able to ‘store’ the incident X-ray radiation and this information can be released as a pattern at an appropriate condition. This allows for the ability to image an object remotely over a long period of time. Further, the flexibility of the polymer matrix allows the X-ray detecting film to conform to non-planar surfaces, and thus allows for a more accurate and scalable imaging.

In some embodiments, the luminescence from the persistent luminescent nanoparticle is able to last for at least 15 days after exposure to X-ray radiation.

In some embodiments, the luminescence from the persistent luminescent nanoparticle is emittable under thermal stimulation of at least 50° C.

In some embodiments, the polymer matrix is a silicone-based polymer matrix.

In other embodiments, the polymer matrix has a thickness of about 1 mm.

In other embodiments, the polymer matrix is stretchable.

In other embodiments, the X-ray detecting film is stretchable up to about 600% of its original length.

In other embodiments, when the X-ray detecting film is stretched to about 600% of its original length, a spatial resolution of the X-ray detector is increased by about 600%.

The present invention also provides a method of fabricating an X-ray detecting film, comprising:
a) mixing persistent luminescent nanoparticles with a liquid polymer to form a polymer mixture; and
b) curing the polymer mixture;
wherein the persistent luminescent nanoparticles are lanthanide-doped nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd³⁺; Sr₂MgSi₂O₇: Eu²⁺,Dy³⁺; CaS:Eu²⁺,Dy³⁺; Y₂O₂S:Eu³⁺, Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); Eu²⁺ doped silicate or borate glasses; and
wherein the persistent luminescence nanoparticles are dispersed in the flexible polymer matrix at a concentration of about 0.1% to about 100%.

In some embodiments, the persistent luminescent nanoparticles are provided to the liquid polymer as a dispersion in a non-polar solvent.

In other embodiments, the non-polar solvent is cyclohexane or toluene.

In other embodiments, the polymer mixture is cured in a mould.

In other embodiments, the step of curing the polymer mixture comprises degassing the polymer mixture and heating the polymer mixture at about 80° C. for at least 4 hours.

The present invention also provides a method of X-ray imaging an object using an X-ray detecting film, comprising:
a) contacting the object with an X-ray detecting film as disclosed herein;
b) exposing the object with the X-ray detecting film to X-rays; and
c) acquiring an X-ray image from the X-ray detecting film by thermally stimulating the X-ray detecting film at a temperature of at least 50° C.,
wherein X-ray images are obtainable over at least 15 days.

In some embodiments, the X-ray image is obtained using a camera.

In some embodiments, the X-ray detecting film is thermally stimulated at a temperature of about 50° C. to about 95° C.

In some embodiments, the X-ray images is removable after exposure to a temperature of more than 100° C.

In some embodiments, when the X-ray detecting film is not thermally stimulated, the X-ray image is storable within the X-ray film for at least 60 days.

### BRIEF DESCRIPTION OF THE DRAWINGS

Embodiments of the present invention will now be described, by way of non-limiting example, with reference to the drawings in which:

FIG. 1 illustrates flexible X-ray imaging based on persistent radioluminescence; and

FIG. 2 illustrates an exemplary flexible-panel-free, flexible and stretchable X-ray detector for high-resolution X-ray imaging.

### DETAILED DESCRIPTION

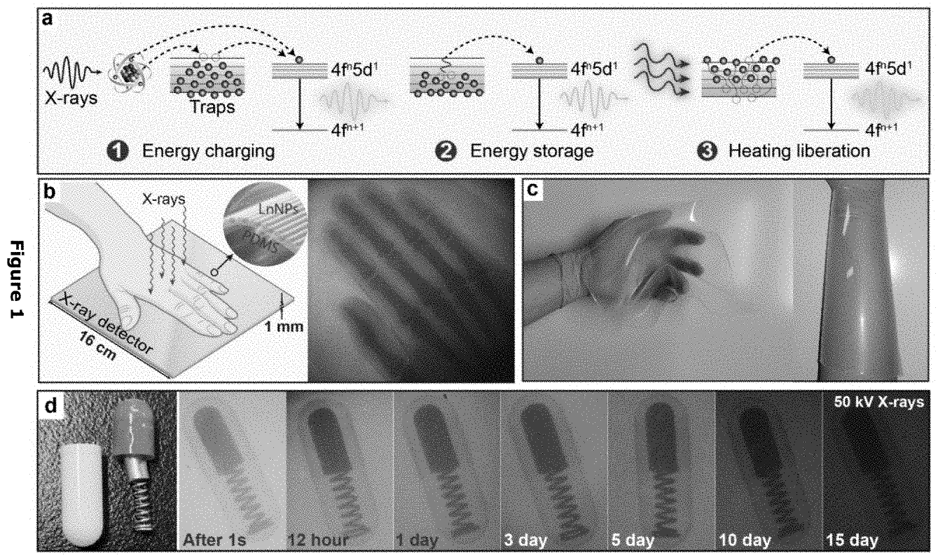

The present invention is predicated on the understanding that X-ray energies can be trapped in nanocrystals. In this context, the inventors believe that this long-lived electron storage ability of nanocrystals can allow for a flat-panel-free X-ray detecting film for digital radiography (FIG. 1a).

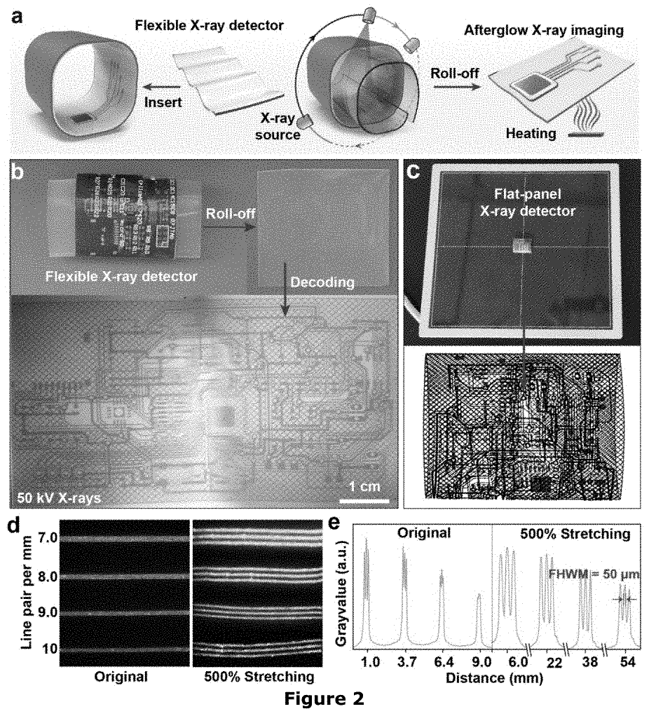

As a general example, as-synthesized lanthanide-doped nanocrystals were embedded into a flexible substrate of polydimethylsiloxane (PDMS) and fabricated as a transparent X-ray detecting film with a thickness of 1 mm and an area of 16×16 cm² (FIGS. 1b&1c). For X-ray imaging, the flexible X-ray detecting film is inserted into the testing object (FIG. 2a). This can be an internal cavity of an apparatus or object. Subsequently, exposure to X-rays allows the X-ray radiation to penetrate through the object and project the radiation onto the X-ray detecting film to form the X-ray contrast memory via long-lived electron trapping. Finally, the X-ray detecting film can be rolled off and the X-ray image captured using a digital camera or smartphone by exposing the X-ray detecting film to heat. This is based on thermally-stimulated afterglow luminescence through quick release of X-ray energies.

In an experiment, a cycle electronic board was chosen as an object to be imaged and the flexible detector inserted within the apparatus for full-view 3D X-ray imaging. As shown in FIG. 2b, the internal structures of the electronic circuits were clearly imaged by the X-ray detecting film, including both their bottom and top sides of the whole device. For comparison, the currently prevailing flat-panel X-ray detecting panel was also used to image the structures of electronic circuits. As shown in FIG. 2c, the heavy and stiff flat-panel detector equipped with α-Si photodiode arrays-highly-integrated TFT substrates showed an overlapped electronic structure. These results suggest that the flexibility of the as-fabricated flat-panel-free X-ray detecting film can realize a precise X-ray imaging which cannot be met by traditional techniques.

The limit of imaging resolution of conventional flat-panel X-ray detectors compared to the X-ray detecting film of the present invention was further explored. Towards this end, persistent luminescent nanocrystals were embedded into another type of commercial silicone rubbers and fabricated it as a flexible and stretchable X-ray detecting film (FIG. 2d). This X-ray detecting film can be handily strained from 10 mm to 60 mm, suggesting the possibility to enhance the spatial resolution of the X-ray imaging. In addition, the finite element simulation reveals that the spatial resolution of triplet lines can be improved by a factor of 600% in principle when the local strain increases to 500%. The stretchability of the X-ray detecting film was tested by measuring the stress-strain curves of the elastomers, suggesting that a low Young's modulus of 0.2 MPa can achieve an elongation of 500%. Comparing with a standard method to benchmark the imaging performance of the stretchable X-ray detecting film (FIG. 2d), the result indicated that its spatial resolution (>10 line-pairs per millimeter (lp/mm)) is much higher than currently prevailing scintillator-sensitized flat-panel X-ray detector (typically below 5.0 Ip/mm) (FIG. 2e). Furthermore, the persistent luminescence-based X-ray detecting film exhibited a long memory of X-ray imaging up to 15 days (FIG. 1d), making them convenient for portable and on-site X-ray imaging outdoors without needing to be powered. For example, the X-ray detecting film can be used in ship inspections.

In particular, FIG. 1 illustrates flexible X-ray imaging based on persistent radioluminescence. Figure la is a schematic representation of the process of energy charging, energy storage, and energy liberation. The X-ray contrast imaging was implemented by radioluminescence projection on the device where the persistent luminescence nanocrystals were photo-excited by X-ray irradiation to emit radioluminescence via Tb³⁺ ions (process 1) and store the excited hot electrons in electronic defects (process 2). The X-ray image was recorded by a digital camera through thermal stimulation-induced radioluminescence at 80° C. (process 3). FIG. 1b illustrates a persistent radioluminescence-based X-ray imaging device made of colloidal nanocrystals-embedded flexible-panel detector (left panel), and a hand phantom X-ray image obtained from the X-ray detecting film operated at an X-ray operation voltage of 50 kV (right panel). FIG. 1c shows photographs of the NaLuF₄:Tb³⁺/Gd³⁺ (15/5 mol %) nanocrystals-embedded flexible X-ray detector. The images show the PDMS-based flexible X-ray detecting film is foldable, stretchable, and high mechanical strength. Figure id shows a photograph (left) and the corresponding X-ray images (right) of an encapsulated metallic spring, recorded with a digital camera at different times from 1 s to 15 days. The X-ray images were acquired by the radioluminescence afterglow of the thin-film device after exposed with X-rays at a voltage of 50 kV and under thermal stimulation at 80° C.

FIG. 2 shows an exemplary flexible-panel-free, flexible and stretchable X-ray detecting film for high-resolution X-ray imaging. FIG. 2a shows a flexible X-ray detecting film fabricated by embedding Tb³⁺-doped NaLuF₄ nanocrystals into the thin-film substrate. The flexible X-ray detecting film is first inserted into the object. Next, the object was irradiated by X-rays and the radiation was projected on the flexible X-ray detecting film. Finally, the flexible X-ray detecting film was taken out and rolled off for digital X-ray imaging via thermally-stimulated radioluminescence afterglow. FIG. 2b shows digital X-ray imaging of an electronic board by the flexible X-ray detecting film. The flat-panel-free, flexible X-ray detecting film was inserted into the electronic board, and then an X-ray source at a voltage of 50 kV was used to produce the imaging contrast of radioluminescence afterglow. Finally, the full-view X-ray image of its electronic structure was recorded by a digital camera upon heating the thin-film detector at 80° C. FIG. 2c shows digital X-ray imaging of an electronic board by the conventional flat-panel X-ray detector. A stress-strain curve of the film in cyclic stress-strain tests for 10 times, with a sample width of 10 mm, thickness of 1 mm, gauge length of 50 mm and loading rate of 100 mm min⁻¹, shows that the X-ray detecting film can withstand high loads without elastic deformation; a tensile strain of up to 500% and tensile stress of up to 1.1 MPa. FIG. 2d illustrates spatial resolution of the flexible X-ray imaging, without and with 500% stretching, characterized by a standard linear mask under X-ray exposure at a voltage of 50 kV. The X-ray image was acquired by a Nikon D850 digital camera equipped with AF-S Micro-Nikkor 40 mm 2.8G. FIG. 2e plots light intensity function of pixels (along the blue line below and FWHM is taken as the resolution) and the X-ray image of a line pair mask.

The present invention provides an X-ray detecting film, comprising a persistent luminescent material dispersed in a flexible polymer matrix.

Persistent luminescent materials are a group of luminescent materials possessing energy storage ability and long-lasting emission after stopping the excitation. Persistent luminescent materials can be a micro-sized material and/or a nano-sized material. Persistent luminescent materials can be lanthanide-doped fluoride materials. For example, the persistent luminescent materials can be a doped perovskite-type halide or an oxyfluoride glass-ceramics material. Examples of persistent luminescence materials are SrAl₂O₄:Eu²⁺, Dy³⁺ with green emission, CaAl₂O₄:Eu²⁺, Nd³⁺ with violet emission, Sr₂MgSi₂O₇:Eu²⁺, Dy³⁺ with blue emission and both CaS:Eu²⁺, Dy³⁺ and Y₂O₂S:Eu³⁺, Mg²⁺, Ti⁴⁺ with red emission. Other persistent luminescence phosphors include Eu²⁺ doped alkaline earth aluminates, MAI₂O₄:Eu²⁺(M=Ca and Sr), complex aluminates, e.g. Eu²⁺ or Ce³⁺ doped melilite based aluminosilicates (Ca₂Al₂SiO₇:Eu²⁺, CaYAl₃O₇:Eu²⁺, Dy³⁺), ceramic materials including calcium magnesium triple silicates (Ca₃MgSi₂O₈:Eu²⁺, Dy³⁺) as well as Mn²⁺ doped zinc gallate (ZnGa₂O₄:Mn²⁺) and Eu²⁺ doped silicate or borate glasses.

The present invention provides an X-ray detecting film, comprising persistent luminescent nanoparticles dispersed in a flexible polymer matrix; wherein the persistent luminescent nanoparticles are lanthanide-doped nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles. The persistent luminescent nanoparticles can also be SrAl₂O₄:Eu²⁺,Dy³⁺; CaAl₂O₄:Eu²⁺,Nd³⁺; Sr₂MgSi₂O₇: Eu²⁺,Dy³⁺; CaS: Eu²⁺,Dy³⁺; Y₂O₂S: Eu³⁺, Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); or Eu²⁺ doped silicate or borate glasses.

The X-ray detecting film is for detecting X-rays. When used in conjunction with an object to be imaged, the X-ray detecting film allows a contrast image to be recorded onto the X-ray detecting film. Advantageously, an X-ray enhancing material is not required to enhance X-ray absorption for increasing X-ray sensitivity.

The nanoparticles are distributed or spread evenly over the whole of the flexible polymer matrix. In some embodiments, the nanoparticles are dispersed homogenously in the polymer matrix. Advantageously, this allows the X-ray detector to have a good contrast across the whole imaging surface. Contrast in visual perception is the difference in appearance of two or more parts of a field seen simultaneously or successively. Visual information is always contained in some kind of visual contrast, thus contrast can be considered a performance feature of electronic visual displays.

The lanthanide or lanthanoid series of chemical elements includes the 15 metallic chemical elements with atomic numbers 57-71, from lanthanum through lutetium. These elements, along with the chemically similar elements scandium and yttrium, are often collectively known as the rare earth elements. In this regard, lanthanide doped nanoparticles include dopants such as La, Ce, Pr, Nd, Pm, Sm, Eu, Gd, Tb, Dy, Ho, Er, Tm, Yb, Lu, Sc and Y.

In some embodiments, the nanoparticles are dispersed in the flexible polymer matrix at a concentration of about 1% to about 10%, about 2% to about 10%, about 3% to about 10%, about 3% to about 9%, about 3% to about 8%, or about 3% to about 7%. In other embodiments, the concentration is about 0.1% to about 100%, about 0.1% to about 99%, about 0.1% to about 90%, about 0.1% to about 80%, about 0.1% to about 70%, about 0.1% to about 60%, about 0.1% to about 50%, about 0.1% to about 40%, about 0.1% to about 30%, about 0.1% to about 20%, about 1% to about 99%, about 10% to about 99%, about 20% to about 99%, about 30% to about 99%, about 40% to about 99%, about 50% to about 99%, about 60% to about 99%, about 70% to about 99%, or about 80% to about 99%.

The inventors have found that when the concentration is in the above range, a good resolution of X-ray imaging can be obtained. The display resolution or of a display device can be thought of as the number of distinct ‘pixels’ in each dimension that can be displayed. Accordingly, when the nanoparticle concentration is increased, the sensitivity of the X-ray detecting film is also enhanced. Further advantageously, when the nanoparticle concentration is high, the intensity of the incoming X-ray can be reduced and which still provides an image with a high resolution. This improves the safety requirements of using the X-ray detecting film. In contrast, when the concentration is below this range, the resolution of the image is low.

In some embodiments, the X-ray detecting film comprises persistent luminescent nanoparticles dispersed in a flexible polymer matrix;
wherein the persistent luminescent nanoparticles are lanthanide-doped nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd³⁺; Sr₂MgSi₂O₇: Eu²⁺,Dy³⁺; CaS: Eu²⁺,Dy³⁺; Y₂O₂S: Eu³⁺, Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); Eu²⁺ doped silicate or borate glasses; and
wherein the persistent luminescence nanoparticles are dispersed in the flexible polymer matrix at a concentration of about 0.1% to about 100%.

In some embodiments, the X-ray detecting film comprises persistent luminescent nanoparticles dispersed in a flexible polymer matrix;
wherein the persistent luminescent nanoparticles are lanthanide-doped nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; and
wherein the persistent luminescence nanoparticles are dispersed in the flexible polymer matrix at a concentration of about 1% to about 10%.

Radioluminescence is the phenomenon by which light is produced in a material by bombardment with ionizing radiation such as alpha particles, beta particles, or gamma rays. Radioluminescence occurs when an incoming particle of ionizing radiation collides with an atom or molecule, exciting an orbital electron to a higher energy level. The particle usually comes from the radioactive decay of an atom of a radioisotope, an isotope of an element which is radioactive. The electron then returns to its ground energy level by emitting the extra energy as a photon of light.

Persistent luminescent nanoparticles or nanocrystals have a physical mechanism that enables photon emission for several seconds to hours after the end of the excitation; i.e. photon emission is long lasting. Excitation can be carried out by means of X-rays. This excitation induces the formation of an exciton (i.e. electron-hole pair) which will be separated. Part of the energy captured will thus be “stored” in electron traps. Said trapped electron can then be released by means of thermal activation to be recombined with an emitter with consequent emission of a photon. The emission of a photon can be by way of luminescence.

The phenomenon of persistent luminescence must not be mistaken for fluorescence and phosphorescence. In fluorescence, the lifetime of the excited state is in the order of a few nanoseconds and in phosphorescence, even if the lifetime of the emission can reach several seconds, the reason for the long emission is due to the deexcitation between two electronic states of different spin multiplicity. For persistent luminescence, it is believed that the phenomenon involves energy traps (such as electron or hole traps) in a material which are filled during the excitation. After the excitation, the stored energy is gradually released to emitter centers which emit light.

As used herein, the term “nanoparticle” is used to refer to a particle having a size, defined as the greatest dimension along an axis, generally between 1 nm and 100 nm.

A persistent luminescent nanoparticle can consist of, as non-limitative examples, a compound such as CdSiO₃:Mn²⁺, ZnGa₂O₄:Mn²⁺, ZnS:Cu or Y₂O₂S:Ti, Mg, Ca. It may consist of a compound of the silicates, aluminates, aluminosilicates, germanates, titanates, oxysulfides, phosphates or vanadates type, said compound comprising at least one metal oxide and being doped with at least one rare earth ion, and possibly with at least one transition metal ion (for example manganese or trivalent chromium). It may also consist of sulfides comprising at least one metal ion selected from zinc, strontium and calcium, doped with at least one rare earth ion, and possibly with at least one transition metal ion. Examples also include metal oxides, again doped with at least one rare earth ion and possibly with at least one transition metal ion.

The nanoparticles can consist of a compound selected from the group consisting of silicates, aluminates, aluminosilicates, germanates, titanates, oxysulfides, phosphates and vanadates, such compounds comprising at least one metal oxide, sulfides comprising at least one metal ion selected from zinc, strontium and calcium, and metal oxides, said compound being doped with at least one rare earth ion, and possibly with at least one transition metal ion.

Examples of oxysulfides include yttrium-based compounds such as yttrium oxide sulfides (Y₂O₂S, etc.). The germanates include MGeO₃ wherein M is magnesium, calcium or zinc, preferentially magnesium (Mg²⁺) and calcium (Ca²⁺), such germanates being preferentially doped with manganese ions and a trivalent ion from the lanthanide series. Examples of titanates include MO—TiO₂ wherein M is magnesium or zinc, and the sulfides include zinc sulfide (ZnS), calcium sulfide (CaS) and strontium sulfide (SrS).

The metal of the metal oxide may be of any type. For example, it can be selected from magnesium, calcium, strontium, barium, zinc, cadmium, yttrium and gallium. The transition metal may be of any type. For example, the transition metal can be selected from manganese, chromium and titanium (Mn²⁺, Cr³⁺, Ti⁴⁺, etc.). The rare earth ion may be of any type. For example, the rare earth ion can be selected from europium, ytterbium, cerium, samarium, praseodymium, dysprosium, neodymium, holmium, terbium, thulium and erbium ions. The rare earth ion is found in the trivalent form thereof (Ce³⁺, Dy³⁺, Nd³⁺, Ho³⁺, Er³⁺, etc.) except for europium, samarium and ytterbium, which may also be found in the divalent form thereof (Eu²⁺, Sm²⁺ and Yb²⁺).

The compositional formula expression of the persistent luminescence nanoparticle can contain a colon “:”, wherein the composition of the main optical host material is indicated on the left side of the colon, and the activators (or dopant ions) or co-dopant ions are indicated on the right side of the colon. The atomic percentage of the dopants or activator ions and/or the atomic percentage of the co-dopant ions can also be indicated to the right side of the colon.

For example, the atomic percentage of a dopant ions (e.g., a divalent europium ion or a monovalent iodine ion) can be expressed in atomic percentage relative to the total amount of dopant and alkali earth metal or total amount of dopant and alkali metal. For example, KCaI₃:Eu 5% or KCaI₃:3% Eu represents a KCaI₃ optical material activated by europium, wherein 3 atomic % of the calcium is replaced by europium. In some embodiments, the dopant is a monovalent ion that substitutes for a percentage of the alkali metal ion in the base metal halide composition. Thus, the atomic % of a monovalent dopant can be expressed as the atomic % relative to the total amount of dopant and alkali metal. The atomic % of the co-dopant ions can be expressed as the atomic or mole % relative to the total amount of cation (i.e., the total amount of alkali metal, alkali earth metal, dopant ion and co-dopant ions).

The compositional formula expression of the persistent luminescence nanoparticle can contain a “@”, wherein the shell component of the nanoparticle is indicated on the right side of “@”.

The inventors have found a way to release the stored energy in the persistent luminescence nanoparticles only ‘on demand’. In this regard, it was found that when persistent luminescent nanoparticles are used, the stored energy is more readily retained in the energy traps or defects of the lattice. This is believed to be due to the stabilisation of the defects in the lattice. With excitation via, for example, heat, the electrons can escape from the energy traps and thus generate a luminescence image.

In some embodiments, the persistent luminescent nanoparticles are lanthanide-doped nanoparticles. In some embodiments, the lanthanide is selected from La, Ce, Pr, Nd, Pm, Sm, Eu, Gd, Tb, Dy, Ho, Er, Tm, Yb, Lu, Sc and Y. In other embodiments, the nanoparticle is selected from Tb-doped NaYF₄, Tb-doped NaGdF₄ and Tb-doped NaLuF₄. Other nanoparticles with other dopant can also be used as the persistent luminescent nanoparticles. For example, the nanoparticles can be doped with Gd, Eu, Yb, or Er. In other embodiments, the persistent luminescent nanoparticles are core-shell persistent luminescent nanoparticles. For example, NaLuF₄:Tb³⁺/Gd³⁺(15/5 mol %) @NaYF₄ can be used. In other embodiments, the persistent luminescent nanoparticles are lanthanide-doped fluoride nanoparticles. In other embodiments, the persistent luminescent nanoparticles are core-shell lanthanide-doped fluoride nanoparticles.

In some embodiments, the nanoparticles are doped with a dopant of about 8% to about 25%. In other embodiments, the amount of dopant is about 10% to about 20%. In other embodiments, the amount of dopant is about 10%, about 12%, about 14%, about 16%, about 18%, or about 20%.

In some embodiments, the nanoparticles have a size of about 100 nm. In other embodiments, the nanoparticles have a size of about 80 nm, 90 nm, 110 nm, 120 nm, 130 nm, 140 nm, 150 nm, 160 nm, 170 nm, 180 nm, 190 nm or 200 nm. In other embodiments, the nanoparticles have a size of about 80 nm to about 200 nm, about 90 nm to about 180 nm, about 90 nm to about 150 nm, or about 90 nm to about 120 nm.

In some embodiments, the nanoparticles comprises a single type of nanoparticle. In other embodiments, the nanoparticles comprises a combination of two or more types of nanoparticles. The nanoparticles can be selected from the nanoparticles as disclosed herein.

In some embodiments, the luminescence from the persistent luminescent nanoparticle is able to persist or last for at least 2 days after exposure to X-ray radiation. In other embodiments, the persistent luminescence is at least 5 days, 8 days, 10 days, 12 days or 15 days. In other embodiments, the luminescence can persist for at least 11 days, 12 days, 13 days, 14 days or 15 days.

In some embodiments, the luminescence from the persistent luminescent nanoparticles is emittable under thermal stimulation at a temperature of at least 50° C. In other embodiments, the thermal stimulation is of at least 60° C., 70° C., 80° C., or 90° C. In this regard, imaging can be performed as and when needed.

In some embodiments, the polymer matrix is a flexible polymer matrix. The polymer matrix is flexible in the sense that it is capable of bending easily without breaking. The polymer matrix can be polydimethylsiloxane (PDMS). Other polymers can be used. For example, silicone-based polymers can be used. For example, silicone rubber Ecoflex 30 (Smooth-On) can be used.

In other embodiments, the polymer matrix has a thickness of about 1 mm. In other embodiments, the thickness is about 2 mm, about 3 mm, about 4 mm, about 5 mm, about 6 mm, about 7 mm, about 8 mm, about 9 mm, or about 10 mm. In other embodiments, the thickness is about 1 mm to about 10 mm, about 1 mm to about 9 mm, about 1 mm to about 8 mm, about 1 mm to about 7 mm, about 1 mm to about 6 mm, about 1 mm to about 5 mm, or about 1 mm to about 4 mm.

Advantageously, an X-ray detecting film with an appropriate thickness allows for it to be fitted within an apparatus for imaging the internal structure of the apparatus. Further, an appropriate thickness allows the X-ray detecting film to maintain its flexibility without breaking. An appropriate thickness also allows sufficient X-rays to be absorbed.

In some embodiments, the polymer matrix has a transparency of more than 80%. In other embodiments, the polymer matrix has a transparency of more than 85%, 90%, 91%, 92%, 93%, 94%, 95%, 96%, 97%, 98% or 99%.

Advantageously, a transparent polymer matrix allows for a good quality contrast image to be captured.

In other embodiments, the polymer matrix is stretchable. The polymer can be capable of being stretched and resuming its former size or shape. By stretching the X-ray detector before obtaining the X-ray image, a better resolution can be obtained.

In other embodiments, the X-ray detecting film has a Young's modulus of about 0.2 MPa. In other embodiments, the Young's modulus is about 0.3 MPa, about 0.4 MPa, about 0.5 MPa, about 0.6 MPa, about 0.7 MPa, about 0.8 MPa, about 0.9 MPa, or about 1 MPa.

In other embodiments, the X-ray detecting film is stretchable up to about 600% of its original length. The original length of the X-ray detecting film is its length as-fabricated. The film can be resilient such that removing the tension allows the film to return to its original length. In other embodiments, the X-ray detecting film is stretchable up to about 500%, about 450%, about 400%, about 350%, about 300%, about 250%, about 200%, about 150%, about 100%, or about 50% of its original length. For example, PDMS can be stretched to about 120% of its original length, while silicone rubber polymers can be stretched to about 600% of their original length.

In other embodiments, when the X-ray detecting film is stretched to about 600% of its original length, a spatial resolution of the X-ray detecting film is increased by about 600%. In other embodiments, the spatial resolution can be increased by about 10,000%, 9,500%, 9,000%, 8,500%, 8,000%, 7,500%, 7,000%, 6,500% 6,000%, 5,500%, 5,000% 4,500%, 4,000%, 3,500%, 3,000%, 2,500%, 2,000%, 1,500%, 1,000%, 800%, 550%, about 500%, about 450%, about 400%, about 350%, about 300%, about 250%, about 200%, about 150%, about 100%, or about 50%. The spatial resolution increment can depend on the property of the polymer matrix.

For example, when stretched, the spatial resolution spatial resolution of the X-ray detecting film can be more than 5 lp/mm, more than 6 lp/mm, more than 7 lp/mm, more than 8 lp/mm, more than 9 lp/mm, more than 10 lp/mm, more than 12 lp/mm, more than 15 lp/mm, or more than 20 lp/mm.

In some embodiments, the polymer matrix is elastic. In this regard, a deformed polymer matrix is able to return to its original shape and size when the forces causing the deformation are removed.

Accordingly, in some embodiments, the X-ray detecting film comprises persistent luminescent nanoparticles dispersed in a flexible polymer matrix; wherein the persistent luminescent nanoparticles are lanthanide-doped fluoride nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd³⁺; Sr₂MgSi₂O₇: Eu²⁺,Dy³⁺; CaS: Eu²⁺,Dy³⁺; Y₂O₂S: Eu³⁺, Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); Eu²⁺ doped silicate or borate glasses; and
wherein the persistent luminescence nanoparticles are dispersed in the flexible polymer matrix at a concentration of about 0.1% to about 100%.

In some embodiments, the X-ray detecting film comprises persistent luminescent nanoparticles dispersed in a flexible polymer matrix;
wherein the persistent luminescent nanoparticles are lanthanide-doped fluoride nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; and
wherein the persistent luminescence nanoparticles are dispersed in the flexible polymer matrix at a concentration of about 1% to about 10%.

In other embodiments, the X-ray detecting film comprises persistent luminescent nanoparticles dispersed in a flexible polymer matrix;
wherein the persistent luminescent nanoparticles are lanthanide-doped fluoride nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles;
wherein the persistent luminescent nanoparticles are dispersed in the flexible polymer matrix at a concentration of about 1% to about 10%;
wherein the luminescence from the persistent luminescent nanoparticles is able to persist for at least 15 days after exposure to X-ray radiation;
wherein the luminescence from the persistent luminescent nanoparticle is emittable under thermal stimulation at about 80° C.;
the X-ray detector having a Young's modulus of about 0.2 MPa and is stretchable up to about 600% of its original length;
wherein when the X-ray detector is stretched to about 600% of its original length, a spatial resolution of the X-ray detector is increased by about 600%.

In some embodiments, the X-ray detecting film comprises persistent luminescent nanoparticles dispersed in a flexible polymer matrix;
wherein the persistent luminescent nanoparticles are NaLuF₄:Tb³⁺/Gd³⁺ (15/5 mol %) ©NaYF₄ nanoparticles;
wherein the persistent luminescent nanoparticles are dispersed in the flexible polymer matrix at a concentration of about 1% to about 10%;
wherein the luminescence from the persistent luminescent nanoparticles are able to persist for at least 15 days after exposure to X-ray radiation;
wherein the luminescence from the persistent luminescent nanoparticles is emittable under thermal stimulation at about 80° C.;
the X-ray detector having a Young's modulus of about 0.2 MPa and is stretchable up to about 600% of its original length;
wherein when the X-ray detector is stretched to about 600% of its original length, a spatial resolution of the X-ray detector is increased by about 600%.

The present invention also provides a method of fabricating an X-ray detecting film, comprising:
a) mixing a persistent luminescent material with a liquid polymer to form a polymer mixture; and
b) curing the polymer mixture.

In some embodiments, the method of fabricating an X-ray detecting film comprises:
a) mixing persistent luminescent nanoparticles with a liquid polymer to form a polymer mixture; and
b) curing the polymer mixture;
wherein the persistent luminescent nanoparticles are lanthanide-doped nanoparticle selected from at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd³⁺; Sr₂MgSi₂O₇:Eu²⁺,Dy³⁺; CaS:Eu²⁺,Dy³⁺; Y₂O₂S: Eu³⁺, Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); or Eu²⁺ doped silicate or borate glasses.

In some embodiments, the method of fabricating an X-ray detecting film comprises:
a) mixing persistent luminescent nanoparticles with a liquid polymer to form a polymer mixture; and
b) curing the polymer mixture;
wherein the persistent luminescent nanoparticles are lanthanide-doped nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles.

In some embodiments, the method of fabricating an X-ray detecting film comprises:
a) mixing persistent luminescent nanoparticles with a liquid polymer to form a polymer mixture; and
b) curing the polymer mixture;
wherein the persistent luminescent nanoparticles are lanthanide-doped nanoparticles such as Tb-doped NaYF₄ nanoparticles, Tb-doped NaGdF₄ nanoparticles, Tb-doped NaLuF₄ nanoparticles or their corresponding core-shell nanoparticles; and
wherein the persistent luminescence nanoparticles are dispersed in the flexible polymer matrix at a concentration of about 1% to about 10%.

In some embodiments, the method of fabricating an X-ray detecting film comprises:
a) mixing persistent luminescent nanoparticles with a liquid polymer to form a polymer mixture; and
b) curing the polymer mixture;
wherein the persistent luminescent nanoparticles are lanthanide-doped fluoride nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles; and
wherein the persistent luminescence nanoparticles are dispersed in the flexible polymer matrix at a concentration of about 1% to about 10%.

In some embodiments, the method of fabricating an X-ray detecting film comprises:
a) mixing persistent luminescent nanoparticles with a liquid polymer to form a polymer mixture; and
b) curing the polymer mixture;
wherein the persistent luminescent nanoparticles are lanthanide-doped fluoride nanoparticles selected from at least one of Tb-doped NaYF₄ nanoparticles, Tb-doped NaGdF₄ nanoparticles, Tb-doped NaLuF₄ nanoparticles or their corresponding core-shell nanoparticles;
wherein the persistent luminescent nanoparticles are dispersed in the flexible polymer matrix at a concentration of about 1% to about 10%;
wherein the luminescence from the persistent luminescent nanoparticles is able to persist for at least 15 days after exposure to X-ray radiation; wherein the luminescence from the persistent luminescent nanoparticles is emittable under thermal stimulation at about 80° C.

The liquid polymer can be SYLGARD™ 184 silicone elastomer. Alternatively, Ecoflex 30 (Smooth-On) mixture can be used.

In some embodiments, the persistent luminescent nanoparticles are provided to the liquid polymer as a dispersion in a non-polar solvent. In this sense, the persistent luminescent nanoparticles can be mixed into the liquid polymer as a dispersion by using a non-polar solvent.

As used herein, non-polar solvents are liphophilic solvents as they dissolve non-polar substances. Examples of non-polar solvents are carbon tetrachloride, benzene, and diethyl ether, hexane and methylene chloride. Also included within this definition are solvent systems which results in a final single phase, and which a major component is a non-polar solvent. The major component can be about 60%, about 65%, about 70%, about 75%, about 80%, about 85%, about 90%, about 95%, or about 99%.

In other embodiments, the non-polar solvent is cyclohexane or toluene.

In other embodiments, the polymer mixture is cured in a mould.

In other embodiments, the step of curing the polymer mixture comprises degassing the polymer mixture and heating the polymer mixture at about 80° C. for at least 4 hours.

The present invention also provides a method of X-ray imaging an object, comprising:
a) contacting the object with an X-ray detecting film as disclosed herein;
b) exposing the object with an X-ray detecting film to an X-ray radiation; and
c) acquiring an X-ray image from the X-ray detecting film by thermally stimulating the X-ray detecting film at a temperature of at least 50° C.; and
wherein X-ray images are obtainable over at least 15 days.

The X-ray detecting film can be conformably positioned on an internal surface of the object. For example, the X-ray detecting film can be placed within the object.

The X-ray image can be acquired from the X-ray detecting film by thermally stimulating the X-ray detecting film at a temperature of at least 50° C. In other embodiments, the temperature is at least 60° C., at least 70° C., at least 80° C., or at least 90° C. In other embodiments, the temperature is about 50° C. to about 95° C., about 60° C. to about 95° C., about 70° C. to about 95° C., or about 80° C. to about 95° C.

By thermally stimulating the X-ray detecting film, an image will form on the X-ray detector. This image can be captured using any appropriate means. In some embodiments, the X-ray image is acquired using a camera. The camera can be a digital camera. For example, the X-ray image can be taken by a digital camera with an exposure time of 10 sec. The image can also be captured using a cell phone, charge-coupled device (CCD) or a thin film transistor (TFT) panel.

The X-ray images are obtainable over at least 15 days. In this regard, as the persistent luminescence nanoparticles can emit light over a long duration of time, the X-ray images are stable over at least 15 days. In other embodiments, the X-ray images are obtainable over at least 14 days, 13 days, 12 days, 11 days, 10 days, 9 days, 8 days, 7 days, 6 days, 5 days, 4 days, 3 days, 2 days, or 1 day.

Without thermally stimulating the X-ray detecting film, the persistent luminescent nanoparticles are trapped in the energy traps (such as electron or hole traps) in a material. Accordingly, the X-ray image can be stored within the X-ray film for at least 60 days. In other embodiments, the X-ray image can be stored for at least 50 days, 40 days, 30 days, 25 days, 20 days, 15 days, 10 days, 5 days, 4 days, 3 days, 2 days or 1 day.

The X-ray image can be bleached upon heating to more than 100° C. This allows erasure of the image and for the X-ray film to be reused. The X-ray image can be removed after exposure to a temperature of more than 100° C. The exposure can be for about 5 min, 10 min, 20 min, 30 min or 40 min.

### EXAMPLES

Synthesis of β-NaLuF₄:Ln³⁺/Gd³⁺(x/(20-x) mol %) nanocrystals. Oleic acid-capped NaLuF₄:Ln³⁺/Gd³⁺(x/(20-x) mol %) (Ln³⁺=Pr³⁺, Nd³⁺, Sm³⁺, Tb³⁺, Dy³⁺, Ho³⁺, Er³⁺& Tm³⁺; x=0.5-15) nanocrystals were synthesized using a coprecipitation method. In a typical experiment, a mixture of Ln(CH₃CO₂)₃·xH₂O (0.5 mmol; Ln=Lu, Gd, Tb, Pr, Nd, Sm, Dy, Ho, Er & Tm) in the desired ratio was added into a 50-mL two-necks round-bottom flask containing 5 mL of OA and 7.5 mL of ODE. The mixture was heated to 150° C. under vacuum for 30 min. After cooling down to room temperature, 10 mL of methanol containing 2 mmol NH₄F and 1.25 mmol NaOH was added into the resultant solution. The resulting mixture was vigorously stirred at 50° C. for 30 min, followed by heating at 100° C. under the vacuum for another 10 min. The reaction mixture was quickly heated to 300° C. at a rate of 20° C./min for 1 h under nitrogen atmosphere while stirring. After cooling down to room temperature, the resultant nanocrystals were precipitated out by the addition of ethanol, collected by 8000 rpm centrifugation for 5 min, washed with absolute ethanol, dispersed in 4 mL of cyclohexane, and finally stored in a freezer at 4° C.

Synthesis of β-NaLuF₄:Tb³⁺/Gd³⁺(15/x mol %) nanocrystals. The synthetic procedure for NaLuF₄:Tb³⁺/Gd³⁺(15/x mol %; x=0-35) nanocrystals was identical to the synthesis of NaLuF₄:Tb³⁺/Gd³⁺(x/(20-x) mol %; x=2-20) nanocrystals.

Synthesis of β-NaReF₄:Tb³⁺ (15 mol %) nanocrystals. The synthetic procedure for NaReF₄:Tb³⁺ (15 mol %) (Re=Y or Gd) nanocrystals was identical to the synthesis of NaLuF₄:Tb³⁺(15 mol %) nanocrystals except for heating temperature and heating duration. To a 50-mL round-bottom two-necks flask 5 mL of OA and 7.5 mL of ODE were added with a total amount of 0.5 mmol Re(CH₃CO₂)·xH₂O (Re=Y, Gd & Tb). The resulting mixture were heated at 150° C. for 30 min under stirring and then cooled down to room temperature. After that, the resulting reactant was added with a methanol solution (10 mL) containing NH₄F (2 mmol) and NaOH (1.25 mmol). This reaction solution was heated at 50° C. for 30 min under stirring. Upon removal of methanol by heating at 100° C. for 10 min, the resultant solution was reacted at 295° C. for 1.5 h. The products were precipitated out with ethanol, collected by centrifugation at 8000 rpm for 10 min, washed with absolute ethanol, and finally dispersed in 4 mL cyclohexane.

Synthesis of β-NaLuF₄:Tb³⁺@NaYF₄ core-shell nanocrystals. The β-NaLuF₄:Tb³⁺@NaYF₄ core-shell nanocrystals were prepared via an epitaxial growth method. In a typical experiment, 0.5 mmol Y(CH₃COO)₄H₂O in 4 mL of OA and 16 mL of ODE was heated to 150° C. under vacuum for 30 min and then cooled down to room temperature. The temperature was then decreased to 50° C. and 4 mL of as-prepared core nanocrystals were added to the mixture, and heated at 80° C. for 10 min to evaporate the cyclohexane. After cooling down to room temperature, a solution of 2 mmol NH₄F and 1.25 mmol NaOH dissolved in 10 mL of methanol was added. The resulting mixture was vigorously stirred at 50° C. for 30 min and then heated at 100° C. for 10 min. The reaction mixture was then quickly heated to 295° C. for 1.5 h under nitrogen atmosphere while stirring. After cooling down to room temperature, the resulting core-shell nanocrystals were precipitated out by the addition of ethanol, collected by centrifugation, washed with absolute ethanol, and dispersed in 4 mL cyclohexane.

Fabrication of flexible X-ray detecting film. In a typical experiment, SYLGARD™ 184 silicone elastomer base was premixed with the curing agent (10:1 by mass). Platinum-catalyzed rubber elastomer was prepared by casting the commericial Ecoflex 30 (Smooth-On) mixture (Part A and Part B in 1:1 weight ratio). A cyclohexane solution of NaLuF₄:Tb³⁺/Gd³⁺(15/5 mol %)@NaYF₄ nanocrystals was added to the resultant solution and stirred vigorously. The resultant mixture was poured into a square acrylic plate (16×16 cm²) as a mould for thin film fabrication. The resulting composites were degassed in a vacuum container to remove air bubbles in the mixture. The mixture was finally heated at 80° C. for 4 hours. After cooling down at room temperature, the as-fabricated film (thickness: 1 mm) was peeled from the square acrylic template and used for X-ray imaging.

Digital X-ray imaging. In a typical procedure for X-ray imaging, the flexible X-ray detector was inserted into the electronic boards or placed on its surface. A beam of X-ray source (P357, VJ Technologies Co, Ltd. (Suzhou, China)) or miniature X-ray source (Amptek, Inc., U.S.A.) was irradiated on the sample, and projected onto the thin-film detector. To acquire the X-ray image, the film was rolled off and put on a heating plate at 80° C. and the image was taken by a digital camera (exposure time, 10 s) or a smartphone. The imaging can be easily bleached upon heating over 100° C.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavor to which this specification relates.

1. An X-ray detecting film, comprising:
persistent luminescent nanoparticles dispersed within a flexible polymer matrix;
wherein the persistent luminescent nanoparticles are lanthanide-doped nanoparticles selected from the group consisting of at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd₃₊; Sr₂MgSi₂O₇:Eu²⁺,Dy³⁺; CaS:Eu²⁺,Dy³⁺; Y₂O₂S:Eu³⁺,Mg²⁺,Ti⁴⁺;Eu²⁺ doped alkaline earth aluminates; complex aluminates, calcium magnesium triple silicates; Mn²⁺ doped zinc gallate (ZnGa₂O₄:Mn²⁺); Eu²⁺ doped silicate and borate glasses; and
wherein the persistent luminescent nanoparticles are dispersed in the flexible polymer matrix at a concentration of about 0.1% to about 100%.

2. The X-ray detecting film according to claim 1, wherein the persistent luminescent nanoparticles are dispersed in the flexible polymer matrix at a concentration of about 1% to about 10%.

3. The X-ray detecting film according to claim 1, wherein the luminescence from the persistent luminescent nanoparticles is able to last for at least 15 days after exposure to X-ray radiation.

4. The X-ray detecting film according to claim 1, wherein the luminescence from the persistent luminescent nanoparticles is emittable under thermal stimulation of at least 50° C.

5. The X-ray detecting film according to claim 1, wherein the polymer matrix is a silicone-based polymer.

6. The X-ray detecting film according to claim 1, wherein the polymer matrix has a thickness of about 1 mm.

7. The X-ray detecting film according to any one of claim 1, wherein the polymer matrix is stretchable.

8. The X-ray detecting film according to claim 7, wherein the X-ray detecting film has a Young's modulus of about 0.2 MPa.

9. The X-ray detecting film according to claim 7, wherein the X-ray detecting film is stretchable up to about 600% of its original length.

10. The X-ray detecting film according to claim 7, wherein when the X-ray detecting film is stretched to about 600% of its original length, a spatial resolution of the X-ray detector is increased by about 600%.

11. A method of fabricating an X-ray detecting film, comprising:
a) mixing persistent luminescent nanoparticles with a liquid polymer to form a polymer mixture; and
b) curing the polymer mixture;
wherein the persistent luminescent nanoparticles are lanthanide-doped nanoparticles selected from the group consisting of at least one of Tb-doped NaYF₄ nanoparticles, Tb-doped NaGdF₄ nanoparticles, Tb-doped NaLuF₄ nanoparticles or their corresponding core-shell nanoparticles; SrAl₂O₄:Eu²⁺,Dy³⁺; CaAl₂O₄:Eu²⁺,Nd³⁺; Sr₂MgSi₂O₇:Eu²⁺,Dy³⁺; CaS:Eu²⁺,Dy³⁺; Y₂O₂S:Eu³⁺, Mg²⁺,Ti⁴⁺; Eu²⁺ doped alkaline earth aluminates; complex aluminates, calcium magnesium triple silicates; Mn²⁺ doped zinc gallate (ZnGa₂O₄:Mn²⁺); Eu²⁺ doped silicate and borate glasses; and
wherein the persistent luminescence nanoparticles are dispersed in the flexible polymer matrix at a concentration of about 0.1% to about 100%.

12. The method according to claim 11, wherein the persistent luminescent nanoparticles are provided to the liquid polymer as a dispersion in a non-polar solvent.

13. The method according to claim 12, wherein the non-polar solvent is cyclohexane or toluene.

14. The method according to claim 11, wherein the polymer mixture is cured in a mould.

15. The method according to claim 11, wherein the step of curing the polymer mixture comprises degassing the polymer mixture and heating the polymer mixture at about 80° C. for at least 4 hours.

16. A method of X-ray imaging an object using an X-ray detecting film, comprising:
a) contacting the object with the X-ray detecting film of claim 1;
b) exposing the object with the X-ray detecting film to X-rays; and
c) acquiring an X-ray image from the X-ray detecting film by thermally stimulating the X-ray detecting film at a temperature of at least 50° C.,
wherein X-ray images are obtainable over at least 15 days.

17. The method according to claim 16, wherein the X-ray image is obtained using a camera.

18. The method according to claim 16, wherein the X-ray detecting film is thermally stimulated at a temperature of about 50° C. to about 95° C.

19. The method according to claim 16, wherein the X-ray images are removable after exposure to a temperature of more than 100° C.

20. The method according to claim 16, wherein when the X-ray detecting film is not thermally stimulated, the X-ray image is storable within the X-ray film for at least 60 days.
